(19) United States
(12) Patent Application Publication
(10) Pub. No.: US 2022/0292348 A1
(43) Pub. Date: Sep. 15, 2022

(54) DISTANCE-BASED PAIRS GENERATION FOR TRAINING METRIC NEURAL NETWORKS

(71) Applicant: Smart Engines Service, LLC, Moscow (RU)

(72) Inventors: Ivan Vladimirovich KONDRASHEV, Oktyabrski (RU); Alexander Vladimirovich SHESHKUS, Stary Oskol (RU); Vladimir Viktorovich ARLAZAROV, Moscow (RU)

(21) Appl. No.: 17/495,642

(22) Filed: Oct. 6, 2021

(30) Foreign Application Priority Data
Mar. 15, 2021 (RU) 2021106630

(51) Int. Cl. G06N 3/08; G06F 17/16

(52) U.S. Cl. CPC G06N 3/08; G06F 17/16

(57) ABSTRACT

Distance-based pairs generation for training metric neural networks. In an embodiment, a training batch is generated by generating a vector of distances between pairs of elements of different classes, sorting the vector, splitting the vector into blocks, assigning a coefficient to each block, and selecting pairs from the blocks based on the assigned coefficients. The training batch can then be used to train a metric neural network.

### CROSS-REFERENCE TO RELATED APPLICATIONS

This application claims priority to Russian Patent App. No. 2021106630, filed on Mar. 15, 2021, which is hereby incorporated herein by reference as if set forth in full.

### BACKGROUND

### Field of the Invention

The embodiments described herein are generally directed to training neural networks, and, more particularly, to generating pairs of elements for training a metric neural network.

### Description of the Related Art

Convolutional neural networks (CNNs) for classification are at the forefront of pattern recognition. These networks can achieve acceptable quality at a fast recognition rate, with a relatively small number of trained parameters and arithmetic operations. An exemplary task for such networks is character recognition. Typically, the number of classes that are recognized by these networks is equal to the number of neurons in the last layer.

However, a problem arises in training a network to recognize an alphabet with a large number of characters, such as the Chinese, Japanese, Korean (CJK) alphabets. See, e.g., Ilyuhin et al., “Recognition of images of Korean characters using embedded networks,” 12th Int'l Conference on Machine Vision (ICMV 2019), W. Osten and D. P. Nikolaev, eds., 11433, 273-279, Int'l Society for Optics and Photonics, SPIE, 2020, which is hereby incorporated herein by reference as if set forth in full. In this case, the number of neurons in the last layer becomes very large. Whereas only twenty-six neurons are required for a network to learn English, eleven-thousand-one-hundred-seventy-two neurons are required for a network to learn Korean. Learning such a large number of parameters requires a large amount of data, thereby rendering the training process ineffective.

One solution to this problem is a metric neural network. The idea behind a metric neural network is to match a point in the metric space to an input vector, so that the point is as close as possible to points of the same class and as far as possible from points of different classes. See, e.g., Song et al., “Deep metric learning via lifted structured feature embedding” (2015); and Parkhi et al., “Deep face recognition,” in Proceedings of the British Machine Vision Conference (BMVC), M. W. J. Xianghua Xie and G. K. L. Tam, eds., 41.1-41.12, BMVA Press (September 2015); which are both hereby incorporated herein by reference as if set forth in full.

Metric neural networks are trained using multiple identical branches with the same parameters. When two branches are used, the scheme is called Siamese, and when three branches are used, the scheme is called triplet. See, e.g., Fedorenko et al., “Real-time object-to-features vectorization via Siamese neural networks,” (ICMV 2017); and Hoffer et al., “Deep metric learning using triplet network,” in Similarity-Based Pattern Recognition (SIMBAD 2015); which are both hereby incorporated herein by reference as if set forth in full. FIG. 1 illustrates the training schemes for Siamese and triplet structures. Depending on the selected training scheme, the distances between the outputs of the branches are computed (e.g., according to the L2 norm).

Then, the results of the distance computation are passed to a loss function that is suitable for training the metric neural network. Learning in metric neural networks occurs by distributing classes in the metric space according to the degree of similarity. During the inference process, only one branch remains. The output dimensionality of that branch is equal to the dimensionality of the metric space, rather than the size of the alphabet being learned.

The most popular loss functions used for metric neural networks are contrastive loss, illustrated in FIG. 2A, and triplet loss, illustrated in FIG. 2B. See, e.g., Hadsell et al., “Dimensionality reduction by learning an invariant mapping,” in 2006 IEEE Computer Society Conference on Computer Vision and Pattern Recognition (CVPR 2006), 2, 1735-1742 (2006); Melekhov et al., “Siamese network features for image matching,” in 2016 23rd Int'l Conference on Pattern Recognition (ICPR), 278-383 (2016); and Wu et al., “Sampling matters in deep embedding learning,” CoRR abs/1706.07567 (2017); which are all hereby incorporated herein by reference as if set forth in full. As illustrated in FIG. 2A, contrastive loss uses pairwise distance, and attempts to decrease the distance between elements of the same class to be less than a selected value a, while increasing the distance between elements of different classes to be not less than the selected value a. Triplet loss processes triplets of the type {anchor, positive, negative} . Anchor and positive are of the same class, whereas anchor and negative are of different classes. As illustrated in FIG. 2B, the task of triplet loss is to train the metric neural network so that the distance between the anchor and positive becomes less than the distance between the anchor and negative by an amount that is equal to or greater than a selected value α.

The selection of pairs/triplets and the order of use of pairs/triplets is a significant problem when training metric neural networks. The properties of the elements can be used to solve this problem. For example, since the number “0” is similar to the letter “O”, more attention should be paid to this pair. However, as the size of the alphabet to be learned increases, the number of such pairs generally increases. This makes it difficult to visually evaluate pairs of similar elements.

Selecting the right data (e.g., pairs/triplets) can significantly accelerate network convergence. See, e.g., Simo-Serra et al., “Discriminative learning of deep convolutional feature point descriptors,” (2015), which is hereby incorporated herein by reference as if set forth in full. Most published works use random data selection. See, e.g., Bell et al., “Learning visual similarity for product design with convolutional neural networks,” ACM Transactions on Graphics 34, 98:1-98:10 (2015), which is hereby incorporated herein by reference as if set forth in full. However, there are some works which pay more attention to the issue. For example, Simo-Serra et al. use an aggressive hard-mining strategy. The essence of this strategy is to select those pairs that have the largest error for backpropagation. Thus, the metric neural network is trained on only the hard examples. In Smirnov et al., “Doppelganger mining for face representation learning,” in 2017 IEEE Int'l Conference on Computer Vision Workshops (ICCVW), 1916-1923 (2017), which is hereby incorporated herein by reference as if set forth in full, pairs of faces are selected using a list of doppelgangers. Doppelgangers are identities in a dataset that are in different classes, but look similar and are close to each other in the metric space. To find them, Smirnov et al. use a classifier with the L2-softmax loss function. Schroff et al., “Facenet: A unified embedding for face recognition and clustering,” in 2015 IEEE Conference on Computer Vision and Pattern Recognition (CVPR), 815-823 (2015), which is hereby incorporated herein by reference as if set forth in full, propose utilizing triplets that contain elements of the opposite class (i.e., the negative) that satisfy the condition dₐₚ<dₐₙ<dₐₚ+α, in which dₐₚ is the distance between the anchor and the positive, and dₐₙ is the distance between the anchor and the negative.

### SUMMARY

Systems, methods, and non-transitory computer-readable media are disclosed for generating pairs for training metric neural networks.

In an embodiment, a method is disclosed that uses at least one hardware processor to, over one or more iterations: generate a training batch comprising a plurality of pairs of elements from source data, wherein each pair of elements in at least a subset of the plurality of pairs of elements comprises two elements of different classes in a plurality of classes, and wherein generating the training batch comprises generating a vector of distances between pairs of elements of potentially different classes in the source data, sorting the vector of distances, splitting the vector of distances into a plurality of blocks, assigning a coefficient to each of the plurality of blocks, and selecting pairs from the plurality of blocks based on the assigned coefficients; and train a metric neural network using the training batch.

The vector of distances may be split into K blocks, wherein assigning a coefficient to each of the plurality of blocks comprises: selecting a main block at a position m within the K blocks; and assigning a coefficient C to each block at position k in the K blocks according to

$$C ( k ) = \{ \begin{matrix}1 - ( m - k ) * back , & k < m \\ 1 , & k = m \\ 1 - ( k - m ) * f o r w , & k > m\end{matrix}$$

wherein ƒ orw is a coefficient indicating a forward step from the position m of the main block, and back is a coefficient indicating a backward step from the position m of the main block.

Assigning a coefficient to each of the plurality of blocks may further comprise normalizing each coefficient C using softmax. Assigning a coefficient to each of the plurality of blocks may further comprise multiplying each coefficient C by a number of pairs set for a current one of the one or more iterations. Selecting pairs from the plurality of blocks based on the assigned coefficients may comprise selecting a number of pairs Pₚₐᵢᵣₛ from each block k according to:

$${P}_{pairs} ( k ) = \frac{{e}^{C ( k )}}{{{Σ}^{K}}_{i = 1} {e}^{C ( i )}} * {l}_{i m p}$$

wherein lᵢₘₚ is the number of pairs set for the current iteration, and wherein e is an exponential constant.

The one or more iterations may be a plurality of iterations. The plurality of iterations may overlap in time, such that the generation of training batches and the training of the metric neural network are performed in parallel.

Any of the methods may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates the Siamese and triplet training schemes;

FIGS. 2A and 2B illustrate contrastive loss and triplet loss, respectively;

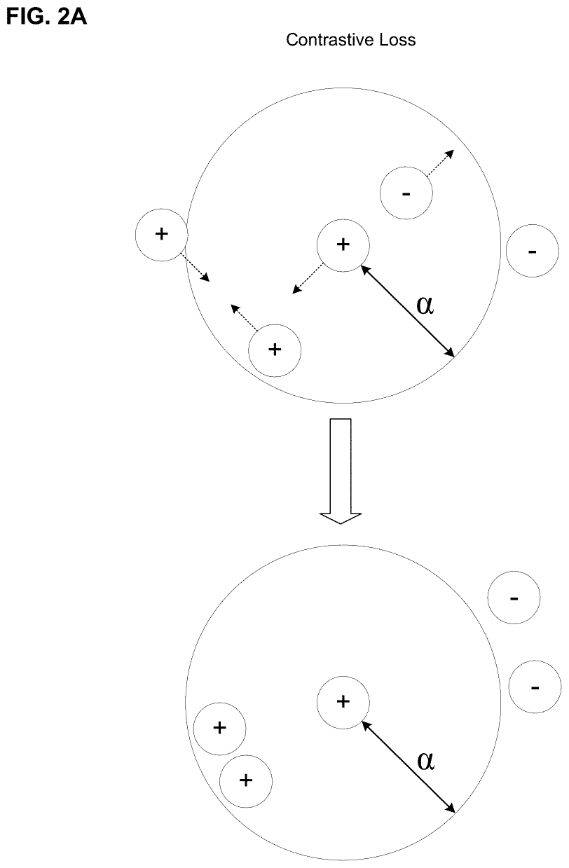

FIG. 3 illustrates an example processing system, by which one or more of the processes described herein, may be executed, according to an embodiment;

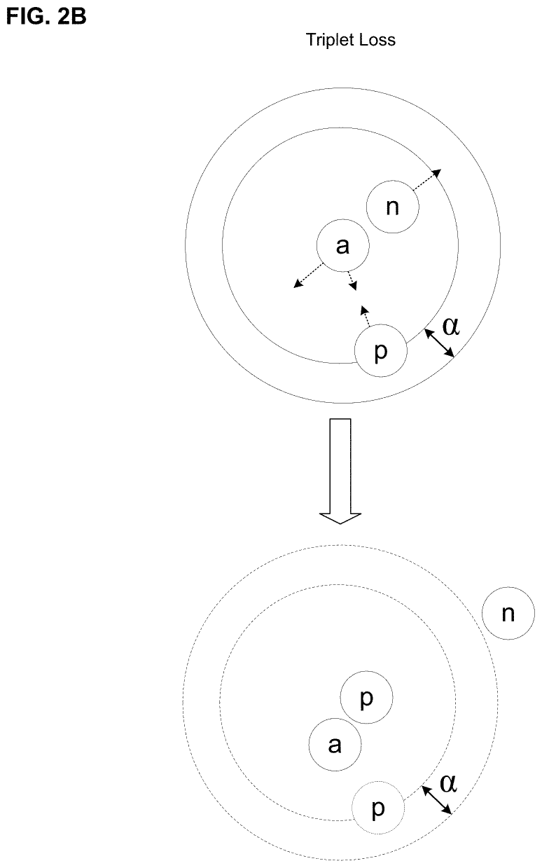

FIG. 4 illustrates a process for distance-based pairs generation, according to an embodiment;

FIG. 5 illustrates an example distribution of pairs that were selected for a training batch, according to a particular implementation of an embodiment;

FIG. 6 illustrates a training process for training a metric neural network, according to an embodiment;

FIG. 7 illustrates an example of a parallel training scheme, according to an embodiment;

FIG. 8 illustrates example images of a Korean character from the PHD08 dataset; and

FIG. 9 illustrates experimental results for different mining methods, including a particular implementation of an embodiment of the disclosed mining method.

### DETAILED DESCRIPTION

In an embodiment, systems, methods, and non-transitory computer-readable media are disclosed for generating pairs for training metric neural networks. After reading this description, it will become apparent to one skilled in the art how to implement the invention in various alternative embodiments and for alternative uses. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Example Processing Device

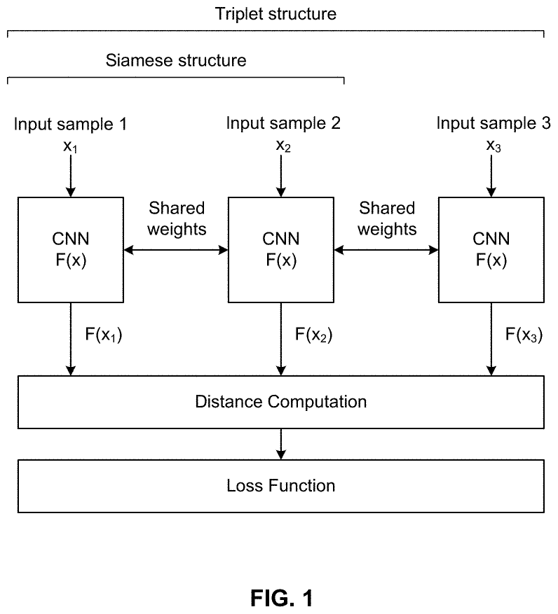

FIG. 1 is a block diagram illustrating an example wired or wireless system 300 that may be used in connection with various embodiments described herein. For example, system 300 may be used to execute one or more of the functions, processes, or methods described herein (e.g., one or more software modules of an application implementing the disclosed processes). System 300 can be a server (e.g., which services requests over one or more networks, including, for example, the Internet), a personal computer (e.g., desktop, laptop, or tablet computer), a mobile device (e.g., smartphone), a controller (e.g., in an autonomous vehicle, robot, etc.), or any other processor-enabled device that is capable of wired or wireless data communication. Other computer systems and/or architectures may be also used, as will be clear to those skilled in the art.

System 300 preferably includes one or more processors, such as processor 310. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 310. Examples of processors which may be used with system 300 include, without limitation, the Pentium® processor, Core i7® processor, and Xeon® processor, all of which are available from Intel Corporation of Santa Clara, California.

Processor 310 is preferably connected to a communication bus 305. Communication bus 305 may include a data channel for facilitating information transfer between storage and other peripheral components of system 300. Furthermore, communication bus 305 may provide a set of signals used for communication with processor 310, including a data bus, address bus, and/or control bus (not shown). Communication bus 305 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-300, and/or the like.

System 300 preferably includes a main memory 315 and may also include a secondary memory 320. Main memory 315 provides storage of instructions and data for programs executing on processor 310, such as one or more of the functions, processes, and/or modules discussed herein. It should be understood that programs stored in the memory and executed by processor 310 may be written and/or compiled according to any suitable language, including without limitation C/C++, Java, JavaScript, Perl, Visual Basic, .NET, and the like. Main memory 315 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 320 may optionally include an internal medium 325 and/or a removable medium 330. Removable medium 330 is read from and/or written to in any well-known manner. Removable storage medium 330 may be, for example, a magnetic tape drive, a compact disc (CD) drive, a digital versatile disc (DVD) drive, other optical drive, a flash memory drive, and/or the like.

Secondary memory 320 is a non-transitory computer-readable medium having computer-executable code (e.g., one or more software modules implementing the disclosed processes) and/or other data stored thereon. The computer software or data stored on secondary memory 320 is read into main memory 315 for execution by processor 310.

In alternative embodiments, secondary memory 320 may include other similar means for allowing computer programs or other data or instructions to be loaded into system 300. Such means may include, for example, a communication interface 340, which allows software and data to be transferred from external storage medium 345 to system 300. Examples of external storage medium 345 may include an external hard disk drive, an external optical drive, an external magneto-optical drive, and/or the like. Other examples of secondary memory 320 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 300 may include a communication interface 340. Communication interface 340 allows software and data to be transferred between system 300 and external devices (e.g. printers), networks, or other information sources. For example, computer software or executable code may be transferred to system 300 from a network server via communication interface 340. Examples of communication interface 340 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 300 with a network or another computing device. Communication interface 340 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 340 are generally in the form of electrical communication signals 355. These signals 355 may be provided to communication interface 340 via a communication channel 350. In an embodiment, communication channel 350 may be a wired or wireless network, or any variety of other communication links. Communication channel 350 carries signals 355 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as one or more software modules implementing the disclosed processes) is stored in main memory 315 and/or secondary memory 320. Computer programs can also be received via communication interface 340 and stored in main memory 315 and/or secondary memory 320. Such computer programs, when executed, enable system 300 to perform the various functions of the disclosed embodiments as described elsewhere herein.

In this description, the term “computer-readable medium” is used to refer to any non-transitory computer-readable storage media used to provide computer-executable code and/or other data to or within system 300. Examples of such media include main memory 315, secondary memory 320 (including internal memory 325, removable medium 330, and/or external storage medium 345), and any peripheral device communicatively coupled with communication interface 340 (including a network information server or other network device). These non-transitory computer-readable media are means for providing executable code, programming instructions, software, and/or other data to system 300.

In an embodiment that is implemented using software, the software may be stored on a computer-readable medium and loaded into system 300 by way of removable medium 330, I/O interface 335, or communication interface 340. In such an embodiment, the software is loaded into system 300 in the form of electrical communication signals 355. The software, when executed by processor 310, preferably causes processor 310 to perform one or more of the processes and functions described elsewhere herein.

In an embodiment, I/O interface 335 provides an interface between one or more components of system 300 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device, in the console of a vehicle, etc.).

In an embodiment, I/O interface 335 provides an interface to a camera (not shown). for example, system 300 may be a mobile device, such as a smartphone, tablet computer, or laptop computer, with one or more integrated cameras (e.g., rear and front facing cameras). Alternatively, system 300 may be a desktop or other computing device that is connected via I/O interface 335 to an external camera. In either case, the camera captures images (e.g., photographs, video, etc.) for processing by processor(s) 310 (e.g., executing the disclosed software) and/or storage in main memory 315 and/or secondary memory 320.

System 300 may also include optional wireless communication components that facilitate wireless communication over a voice network and/or a data network. The wireless communication components comprise an antenna system 370, a radio system 365, and a baseband system 360. In such an embodiment, radio frequency (RF) signals are transmitted and received over the air by antenna system 370 under the management of radio system 365.

In an embodiment, antenna system 370 may comprise one or more antennae and one or more multiplexors (not shown) that perform a switching function to provide antenna system 370 with transmit and receive signal paths. In the receive path, received RF signals can be coupled from a multiplexor to a low noise amplifier (not shown) that amplifies the received RF signal and sends the amplified signal to radio system 365.

In an alternative embodiment, radio system 365 may comprise one or more radios that are configured to communicate over various frequencies. In an embodiment, radio system 365 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 365 to baseband system 360.

If the received signal contains audio information, then baseband system 360 may decode the signal and convert it to an analog signal. Then, the signal is amplified and sent to a speaker. Baseband system 360 may also receive analog audio signals from a microphone. These analog audio signals may be converted to digital signals and encoded by baseband system 360. Baseband system 360 can also encode the digital signals for transmission and generate a baseband transmit audio signal that is routed to the modulator portion of radio system 365. The modulator mixes the baseband transmit audio signal with an RF carrier signal, generating an RF transmit signal that is routed to antenna system 370 and may pass through a power amplifier (not shown). The power amplifier amplifies the RF transmit signal and routes it to antenna system 370, where the signal is switched to the antenna port for transmission.

Baseband system 360 may also be communicatively coupled with processor 310, which may be a central processing unit (CPU). Processor 310 has access to data storage areas 315 and 320. Processor 310 is preferably configured to execute instructions (i.e., computer programs, such one or more software modules implementing the disclosed processes) that can be stored in main memory 315 or secondary memory 320. Computer programs can also be received from baseband processor 360 and stored in main memory 310 or in secondary memory 320, or executed upon receipt. Such computer programs, when executed, enable system 300 to perform the various functions of the disclosed embodiments.

### 2. Process Overview

Embodiments of processes for generating pairs for training metric neural networks, based on distance, will now be described. It should be understood that the described processes may be embodied as an algorithm in one or more software modules, forming an application that is executed by one or more hardware processors processor 310, for example, as a software application or library. The described processes may be implemented as instructions represented in source code, object code, and/or machine code. These instructions may be executed directly by the hardware processor(s) 310, or alternatively, may be executed by a virtual machine operating between the object code and the hardware processor(s) 310. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of steps, each process may be implemented with fewer, more, or different steps and a different arrangement and/or ordering of steps. In addition, it should be understood that any step, which does not depend on the completion of another step, may be executed before, after, or in parallel with that other independent step, even if the steps are described or illustrated in a particular order.

The most commonly used method for creating batches of training data is to generate random pairs. Specifically, different random elements of the same random class are selected as genuine, and random elements of different random classes are selected as imposters. The disadvantage of this method is that all of the generated pairs are used evenly in the learning process, even though there is a need to use some pairs more often than others.

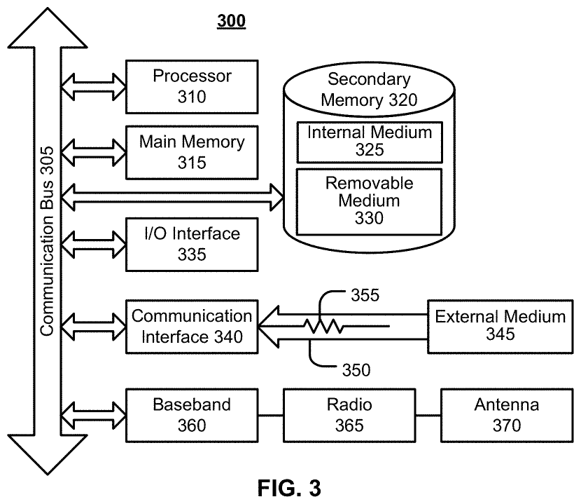

In an embodiment, to avoid this problem, pairs are generated based on the distances between elements in the metric space. FIG. 4 illustrates a process 400 for distance-based pairs generation, according to an embodiment. Process 400 may be implemented in software and executed by one or more processors 310 to produce a training batch of Siamese pairs or triplets (e.g., anchor, positive, and negative) for training a metric neural network.

Initially, in subprocess 410, a vector of distances for all possible imposter pairs is generated. For example, each impostor may be assigned a number (e.g., two-digit number) in a numerical system that is based on the size of the alphabet. Then, all assigned numbers may be converted to a decimal system, resulting in a one-dimensional vector that associates each impostor with a decimal index in the distance vector. The vector may be initialized with values of zero and a length of Mᵢₘₚ, where:

$${M}_{i m p} = \frac{{N}^{2} - N}{2}$$

wherein N is the number of classes.

In subprocess 420, a small amount of uniform noise may be applied to the distance values in the vector. The noise may be used to mix pairs with the same distance values. This noise may be added due to the fact that the number of pairs may be very large, and it is necessary to use all of them in the training process. The use of noise helps sort pairs with the same distance in different ways each time, thereby using them in training equally often.

In subprocess 430, the vector is sorted according to the distance values. For example, the vector may be sorted from smaller to larger distance values. In this case, the pairs at the beginning of the sorted vector represent pairs with the smallest distance values, and therefore, the largest errors, or pairs which have not yet been used.

Using only these hard pairs at the beginning of the vector can lead to bad results, due to errors in the training data or different representations of the same characters in different fonts. For example, a character from Font A may be less similar to the same character from Font B, but look more similar to another character from Font B. The distance of these pairs may not change after training, and therefore, these pairs may always remain at the beginning of the vector. Consequently, using only the hard pairs at the beginning of the vector to train the metric neural network may result in neglecting soft pairs at the end of the vector.

Subprocesses 440-460 are introduced to avoid this problem. Specifically, in subprocess 440, the sorted vector is split into K blocks. The number of K blocks into which to split the sorted vector may be selected experimentally. The block that contains the most pairs is selected as the main block, with a position m within the K blocks.

In subprocess 450, a coefficient C is assigned to each block k in the K blocks. In an embodiment, the coefficients C are assigned according to the following rule:

$$C ( k ) = \{ \begin{matrix}1 - ( m - k ) * back , & k < m \\ 1 , & k = m \\ 1 - ( k - m ) * f o r w , & k > m\end{matrix}$$

wherein forw and back are coefficients indicating the step forward and the step backward, respectively, from position m of the main block. The coefficients C may be normalized using softmax and multiplied by the number of pairs lᵢₘₚ set for the current iteration of process 400. Thus, the number of pairs Pₚₐᵢᵣₛ that are taken from each block k can be represented as a vector in which:

$${P}_{pairs} ( k ) = \frac{{e}^{C ( k )}}{{{Σ}^{K}}_{i = 1} {e}^{C ( i )}} * {l}_{i m p}$$

wherein e is the exponential constant.

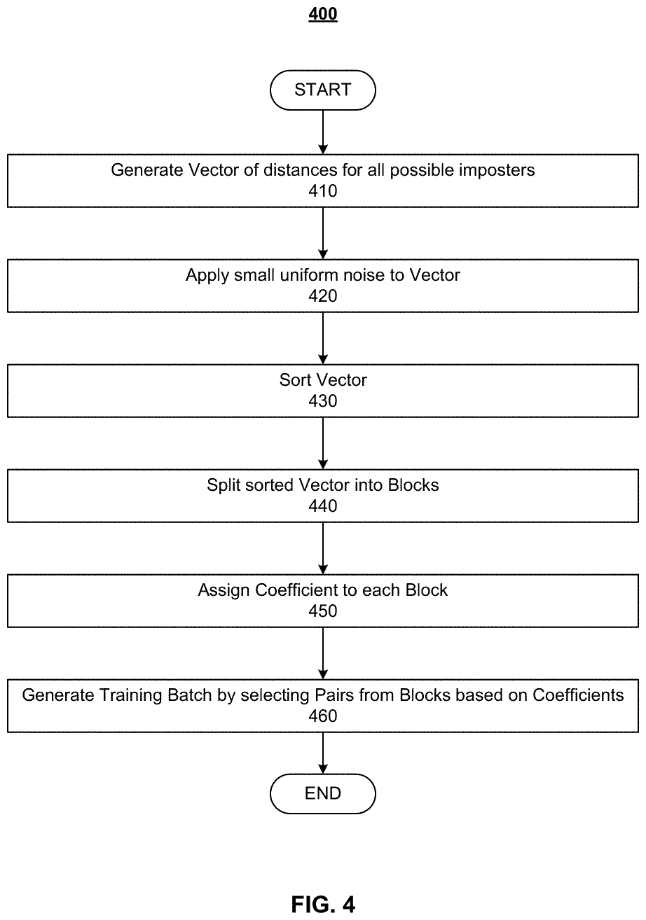

In subprocess 460, a training batch of pairs is generated by selecting pairs from each block k in the quantity specified by Pₚₐᵢᵣₛ(k). The pairs selected from each block k may be selected randomly or by other means. Notably, the parameters ƒ orw, back, and K are responsible for covering all pairs. For example, if ƒ orw and back are decreased, while K is increased, the coverage of all pairs will be greater per iteration. By adjusting the values of back and m, the number of hard pairs taken from the beginning of the vector can be adjusted. In one particular experiment, the following parameter values were selected based on the best convergence when training the metric neural network: K=100, back=0.7, ƒ orw=0.2, and m=11. FIG. 5 illustrates an example distribution of the pairs that were selected for the training batch using these parameter values.

The training batch that is created in subprocess 460 can be passed to the metric neural network for training. A distance vector d^{out} may be compiled after performing forward propagation, and then merged with the old distance vector d^{old} to produce a new distance vector d^{new}, according to the following rule:

$${d}_{i}^{n e w} = max ( {d}_{i}^{old} - \frac{mean ( {D}_{old} ) * {l}_{i m p}}{{M}_{i m p}} , {d}_{i}^{o u t} )$$

wherein dᵢ^{new} is a new value at position i in distance vector d^{new}, dᵢ^{old} is an old value at position i in distance vector d^{old}, dᵢ^{out} is the value received after forward propagation for position i in distance vector d^{out}, and lᵢₘₚ is the number of pairs of imposters to be generated per iteration.

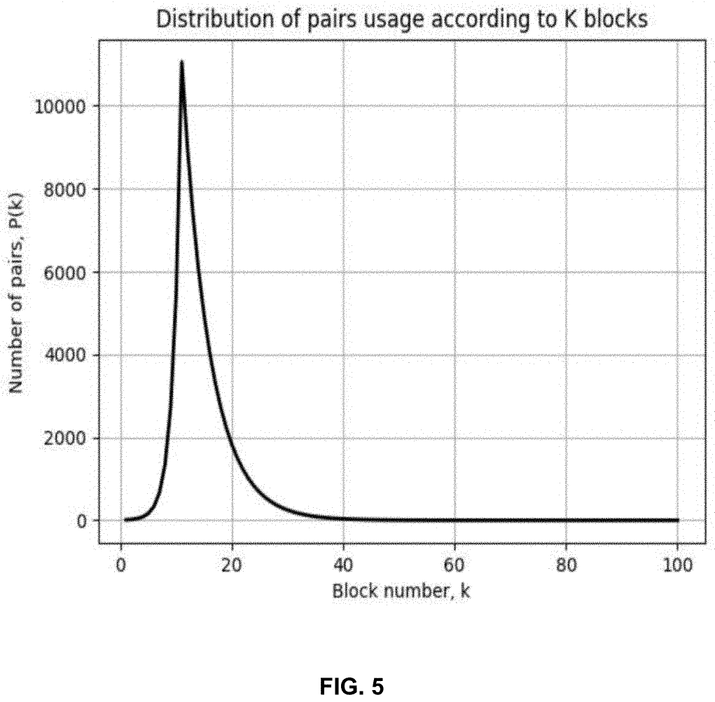

FIG. 6 illustrates a training process 600 for training a metric neural network, according to an embodiment. As illustrated, a training batch is generated using process 400, and then the metric neural network is trained using the generated batch in subprocess 620. These cycles of batch generation in process 400 and training in subprocess 620 occur over one or a plurality of iterations until a stopping condition is satisfied in subprocess 610. The stopping condition may be the completion of a certain number of iterations, the achievement of a certain threshold of accuracy by the metric neural network, and/or any other criterion or set of criteria.

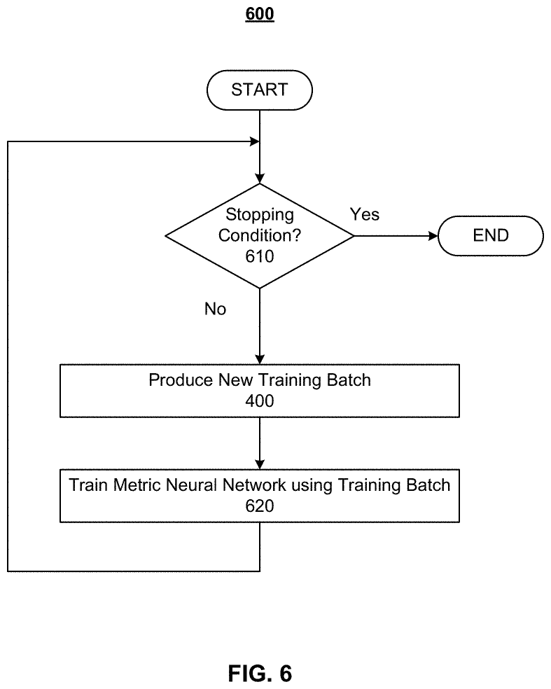

In an embodiment, the generation of training batches in process 400 may occur in parallel with training in subprocess 620. In other words, the generation of training batches and the training may occur in parallel threads. FIG. 7 illustrates an example of these parallel threads, according to an embodiment of a training scheme. The first two training batches bᵢ₋₁ and bᵢ, generated by the first two iterations of process 400A and 400B, may be created randomly before and during training. At the end of training 620A, using the first batch bᵢ₋₁, the distance vector Dᵢ begins to form. Starting from the third batch bᵢ₊₁, the data generation process starts using statistics as discussed herein. This delay from the first batch bᵢ₋₁ to the third batch bᵢ₊₁ is not significant and does not affect the learning results.

### 3. Experimental Results

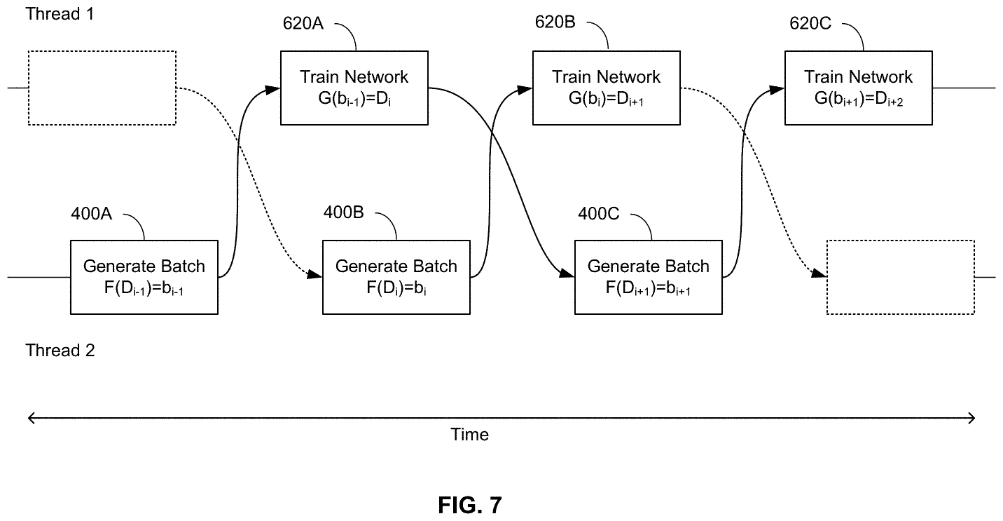

To evaluate a particular implementation of training process 600, the PHD08 dataset was used. The PHD08 dataset is described in Ham et al., “Construction of printed hangul character database PHD08,” Journal of the Korea Contents Association 8, 33-40 (2008), which is hereby incorporated herein by reference as if set forth in full. The PHD08 dataset contains 2,350 classes, and each class has 2,187 images of Korean characters, for a total of 5,139,450 binary images having different sizes, rotations, and distortions. Example images of the Korean character U+B137 from the PHD08 dataset are illustrated in FIG. 8.

Synthetic data for training the metric neural network were generated using the methodology described in Chernyshova et al., “Generation method of synthetic training data for mobile OCR system,” in 10th Int'l Conference on Machine Vision (ICMV 2017), A. Verika, P. Radeva, D. Nikolaev, and J. Zhou, eds., 10696, 640-646, Int'l Society for Optics and Photonics, SPIE (2018), which is hereby incorporated herein by reference as if set forth in full. The created data comprised grayscale patches that were 37×37 pixels in size, with an average of eight images per class. The total number of classes was 11,173 Korean characters. During one iteration, 102,400 pairs were generated, consisting of 30,720 genuines and 71,680 imposters. Data augmentation was used, as described in Gayer et al., “Effective real-time augmentation of training dataset for the neural networks learning,” in 11th Int'l Conference on Machine Vision (ICMV 2018), A. Verikas, D. P. Nikolaev, P. Radeva, and J. Zhou, eds., 11041, 394-401, Int'l Society for Optics and Photonics, SPIE (2019), which is hereby incorporated herein by reference as if set forth in full, with a probability of 0.7 and the following distortions: projective transformation; rotation; and scale. A stochastic gradient descent was used as an optimizer, with a learning rate of 0.01 and a momentum of 0.99.

For the experiment, the architecture described in Ilyuhin et al., comprising two identical branches, was used. Contrastive loss with α=4 was used as a loss function. The architecture of the metric neural network is depicted in the following table:

Layers

| # | Type | Parameters | Activation Function |
|---|---|---|---|
| 1 | convolutional | 16 filters 3 × 3, stride | softsign |
| | | 1 × 1, no padding | |
| 2 | convolutional | 16 filters 5 × 5, stride | softsign |
| | | 2 × 2, padding 2 × 2 | |
| 3 | convolutional | 16 filters 3 × 3, stride | softsign |
| | | 1 × 1, padding 1 × 1 | |
| 4 | convolutional | 24 filters 5 × 5, stride | softsign |
| | | 2 × 2, padding 2 × 2 | |
| 5 | convolutional | 24 filters 3 × 3, stride | softsign |
| | | 1 × 1, padding 1 × 1 | |
| 6 | convolutional | 24 filters 3 × 3, stride | softsign |
| | | 1 × 1, padding 1 × 1 | |
| 7 | fully connected | 25 neurons | — |

Ideal vectors for each class were generated based on the training data. Since the dimension of the output of the last layer is twenty-five, these ideal vectors were points in 25-dimensional metric space. During inference for an element, the element was mapped into the same metric space, and matched to the closest class. Classification accuracy was determined as:

$$Accuracy = \frac{{N}_{correct}}{{N}_{total}} * 100 \%$$

wherein Nₜₒₜₐₗ is the size of the PHD08 dataset (5,139,450 images), and N_{correct} is the number of images correctly recognized by the trained metric neural network.

For the experiment, four methods of mining pairs were used: random mining; hard mining as described in Simo-Serra et al.; training on static data (i.e., 4,096,000 pairs); and the disclosed process 400 that is based on distances between elements. Three identical experiments were performed for each method, and the results were averaged. The results with the best average quality are presented in the table below:

| | Pairs Mining Method | | | |
|---|---|---|---|---|
| | Random | Hard | Static | Distance- |
| | Mining | Mining | Data | Based |
| Accuracy | 63.7% | 64.5% | 59.8% | 69.7% |

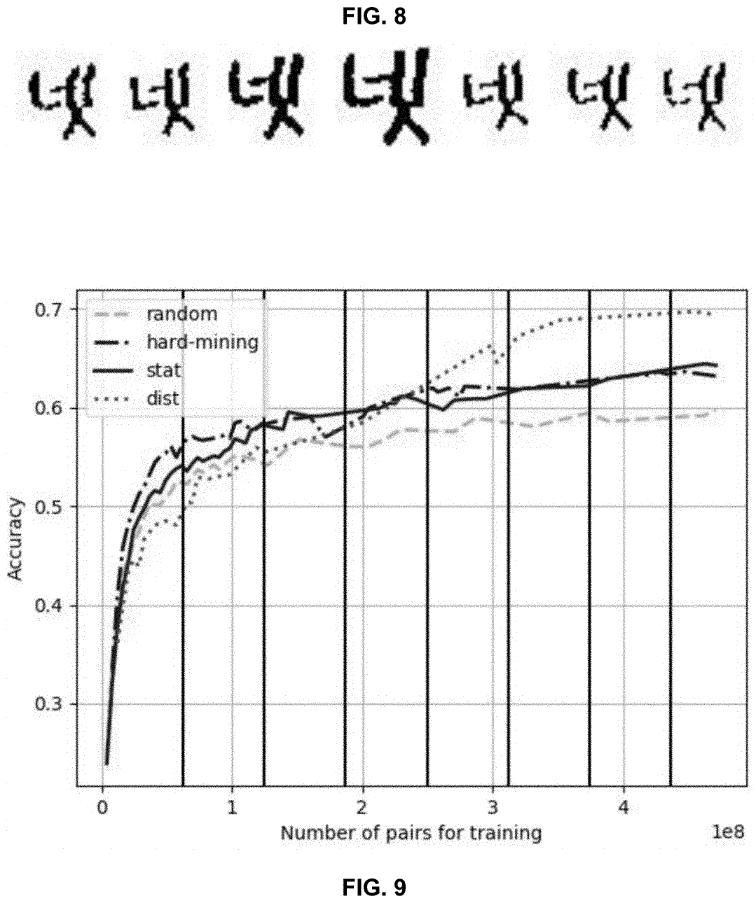

FIG. 9 illustrates the dependence of quality on the number of trained pairs. Black vertical lines in FIG. 9 indicate complete traversal of pairs, provided that pairs are selected that have not yet been selected in the current traversal. The graph in FIG. 9 demonstrates that the disclosed distance-based pairs mining achieved lower quality at the beginning of training, relative to the other mining methods. This time period is associated with a complete traversal of pairs and the accumulation of the distance vector. In contrast, during this time period, the static data mining uses the same pairs, which results in a rapid increase in quality at the beginning of training. However, the disclosed distance-based pairs mining significantly outperformed the other mining methods after accumulating the distance vector. Notably, distance-based pairs mining outperformed hard mining, which is similar but does not utilize the statistics accumulated during training, as described herein.

### 4. Example Embodiment

The inventors have identified that the method by which pairs are generated is an important problem in training metric neural networks, and that a solution to this problem can result in higher quality training of metric neural networks. If the properties of source data are understood, pairs can be selected for training in such a way that the metric neural network will pay more attention to elements of different classes that are close in the metric space. However, a problem arises when these properties are difficult to extract from the source data.

To address this problem, in an embodiment, pairs are generated for training metric neural networks based on the distances between elements in the metric space. The training process may generate pairs using the results of the metric neural network from previous iterations, in parallel with training the metric neural network. Thus, the properties of the elements themselves do not need to be evaluated, and any data can be used as learning objects. Accordingly, this distance-based mining method is universal and suitable for any object detection, including faces and hieroglyphs.

To evaluate the method, the PHD08 dataset of Korean characters was used. Experimental results demonstrated that the disclosed distance-based mining method outperformed other mining methods, including random pair generation, hard mining, and static data mining, in quality.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, over one or more iterations:
generate a training batch comprising a plurality of pairs of elements from source data, wherein each pair of elements in at least a subset of the plurality of pairs of elements comprises two elements of different classes in a plurality of classes, and wherein generating the training batch comprises
generating a vector of distances between pairs of elements of potentially different classes in the source data,
sorting the vector of distances,
splitting the vector of distances into a plurality of blocks,
assigning a coefficient to each of the plurality of blocks, and
selecting pairs from the plurality of blocks based on the assigned coefficients; and
train a metric neural network using the training batch.

2. The method of claim 1, wherein the vector of distances is split into K blocks, and wherein assigning a coefficient to each of the plurality of blocks comprises:
selecting a main block at a position m within the K blocks; and
assigning a coefficient C to each block at position k in the K blocks according to
$$C ( k ) = \{ \begin{matrix}1 - ( m - k ) * back , & k < m \\ 1 , & k = m \\ 1 - ( k - m ) * f o r w , & k > m\end{matrix}$$
wherein ƒ orw is a coefficient indicating a forward step from the position m of the main block, and back is a coefficient indicating a backward step from the position m of the main block.

3. The method of claim 2, wherein assigning a coefficient to each of the plurality of blocks further comprises normalizing each coefficient C using softmax.

4. The method of claim 3, wherein assigning a coefficient to each of the plurality of blocks further comprises multiplying each coefficient C by a number of pairs set for a current one of the one or more iterations.

5. The method of claim 4, wherein selecting pairs from the plurality of blocks based on the assigned coefficients comprises selecting a number of pairs Pₚₐᵢᵣₛ from each block k according to:
$${P}_{pairs} ( k ) = \frac{{e}^{C ( k )}}{{{Σ}^{K}}_{i = 1} {e}^{C ( i )}} * {l}_{i m p}$$
wherein lᵢₘₚ is the number of pairs set for the current iteration, and wherein e is an exponential constant.

6. The method of claim 1, wherein the one or more iterations are a plurality of iterations.

7. The method of claim 6, wherein the plurality of iterations overlap in time, such that the generation of training batches and the training of the metric neural network are performed in parallel.

8. A system comprising:
at least one hardware processor; and
one or more software modules that are configured to, when executed by the at least one hardware processor,
generate a training batch comprising a plurality of pairs of elements from source data, wherein each pair of elements in at least a subset of the plurality of pairs of elements comprises two elements of different classes in a plurality of classes, and wherein generating the training batch comprises
generating a vector of distances between pairs of elements of potentially different classes in the source data,
sorting the vector of distances,
splitting the vector of distances into a plurality of blocks,
assigning a coefficient to each of the plurality of blocks, and
selecting pairs from the plurality of blocks based on the assigned coefficients, and
train a metric neural network using the training batch.

9. A non-transitory computer-readable medium having instructions stored thereon, wherein the instructions, when executed by a processor, cause the processor to:
generate a training batch comprising a plurality of pairs of elements from source data, wherein each pair of elements in at least a subset of the plurality of pairs of elements comprises two elements of different classes in a plurality of classes, and wherein generating the training batch comprises
generating a vector of distances between pairs of elements of potentially different classes in the source data,
sorting the vector of distances,
splitting the vector of distances into a plurality of blocks,
assigning a coefficient to each of the plurality of blocks, and
selecting pairs from the plurality of blocks based on the assigned coefficients; and
train a metric neural network using the training batch.
